(19) United States
(12) Patent Application Publication
(10) Pub. No.: US 2020/0298615 A1
(43) Pub. Date: Sep. 24, 2020

(54) OPTICAL DECORATIVE FILM, MANUFACTURING METHOD, AND COVER PLATE FOR CONSUMER ELECTRONICS

(71) Applicant: Shine Optoelectronics (Kunshan) Co., Ltd., Kunshan City (CN)

(72) Inventor: Yulong Gao, Kunshan (CN)

(21) Appl. No.: 16/898,606

(22) Filed: Jun. 11, 2020

Related U.S. Application Data
(63) Continuation of application No. PCT/CN2019/071548, filed on Jan. 14, 2019.

(30) Foreign Application Priority Data
Feb. 12, 2018 (CN) 201810146052.8

(51) Int. Cl. B44C 5/04; B44C 1/10; H04M 1/02

(52) U.S. Cl. CPC B44C 5/0446; H04M 1/0283; B44C 1/10

(57) ABSTRACT

The present invention discloses an optical decorative film comprising a support layer, an optical layer, and a decorative layer, its manufacturing method, and a cover plate for consumer electronics containing the film. The support layer has a first side and an opposite second side. The optical layer is formed on the first side and comprises a plurality of micro-nano structures in a convex and/or concave arrangement. The decorative layer is provided on the second side and supported by the support layer. The optical decorative film is produced with a dual decorative effect and high distinctiveness, and has only one support layer achieving a relatively small thickness.

### TECHNICAL FIELD

The present invention relates to the field of optics, and in particular to an optical decorative film, a manufacturing method and a cover plate for consumer electronics.

### BACKGROUND

Currently, with the ever progressing development in consumer electronic industries, manufacturers are constantly seeking innovations in technology and functions to keep up with the trend of advances in environmental protection, energy saving, and differentiation development. Designs of consumer electronics are no longer limited to improvement in functions, and many designers are now focusing on the exterior designs of consumer electronics. In the case of cell phones, a cover plate for a cell phone not only protects the parts inside the phone but also beautifies and decorates the phone. A design for a cell-phone cover plate having an excellent decorative effect may not only add value to the cell phone but also improve the experience of a user and broaden the range of choices of cell phone appearances for the user, making the cell phone more popular among users.

However, the decorative designs for a cell-phone cover plate are now focused on alteration in material (e.g., glass, metal, plastic) or changing a single color of the printing ink layer, which results in a monotonous visual effect and therefore an unsatisfactory, less distinctive decoration.

### SUMMARY OF THE INVENTION

In this regard, it is necessary to provide an optical decorative film to solve the above technical problems.

A technical solution according to the present invention is:

an optical decorative film, comprising:
a support layer having a first side and an opposite second side;
an optical layer provided on the first side and having a plurality of micro-nano structures in a convex and/or concave arrangement; and
a decorative layer provided on the second side and supported by the support layer.

In one embodiment, the decorative layer includes a reflective layer overlying the second side and a colored layer overlying the reflective layer.

In one embodiment, a protective layer overlying the optical layer for protecting the micro-nano structures is further provided, and the difference in refractive index between the protective layer and the micro-nano structures is greater than or equal to 0.01.

In one embodiment, the support layer includes a glass layer, a PET layer, a PC layer, or a PMMA layer.

In one embodiment, the transmittance of the support layer and the optical layer is greater than or equal to 10%, or the transmittance of the support layer and the decorative layer is greater than or equal to 10%.

In one embodiment, the decorative layer includes one layer of a texture layer, a graphic layer, or a colorful layer, or superimposed layers of two or more thereof, wherein the texture layer comprises a plurality of texture structures in a convex and/or concave arrangement.

In one embodiment, the decorative layer includes a composite layer of colorful texture layers or colorful graphic layers, wherein the texture layer comprises a plurality of texture structures in a convex and/or concave arrangement.

In one embodiment, the micro-nano structures are one or more of linear cylindrical lens, curved cylindrical lens, micro lens, Fresnel lens, CD patterns, short lines, moth-eye structures, and brushed patterns, with or without spacing provided between the micro-nano structures; the texture structures are one or more of linear cylindrical lens, curved cylindrical lens, micro lens, Fresnel lens, CD patterns, short lines, moth-eye structures, brushed patterns, with or without spacing provided between the texture structures.

In one embodiment, the decorative layer includes a texture layer, and there is no interference between the micro-nano structures and the texture structures.

In one embodiment, the micro-nano structures have a gradient arrangement, and/or the texture structures have a gradient arrangement.

In one embodiment, the graphic layer comprises a UV resin with grooves and a filler filled inside the grooves, and the filler forms the graphic of the graphic layer.

In one embodiment, the colorful layer has a gradient color.

In one embodiment, the colorful layer comprises a UV resin layer with gradient grooves and a colorful material filled inside the grooves, and the colorful layer presents a gradient color.

In one embodiment, the support layer is a PET layer having a thickness larger than that of the decorative layer.

In one embodiment, the optical decorative film has a colored layer, a reflective layer, an optical layer, a support layer, and a decorative layer stacked in this order.

In one embodiment, a colorful layer and/or a graphic layer is further provided between the optical layer and the support layer.

In one embodiment, the decorative layer is stacked with a colorful layer and a texture layer in this order; or the decorative layer is stacked with a graphic layer and a texture layer in this order; or the decorative layer is stacked with a colorful layer and a graphic layer in this order; or the decorative layer comprises a colorful layer, a graphic layer, and a texture layer.

In one embodiment, the decorative layer further comprises a binding layer that binds the decorative layer to the second side of the support layer.

In one embodiment, the colorful layer is a gradient color layer, and/or the texture structures of the texture layer are in a gradient arrangement.

In one embodiment, the decorative layer at least includes two or more colorful layers, and/or the decorative layer at least includes two or more graphic layers, and/or the decorative layer at least includes two or more texture layers.

The present invention further discloses a cover plate for consumer electronics, comprising the optical decorative film as described above.

The present invention further discloses a manufacturing method for an optical decorative film, which method comprises:
applying a polymer on a first side of a support layer, and forming a plurality of micro-nano structures on the polymer;
binding a decorative layer through a binding layer thereof to a second side of the support layer.

An alternative manufacturing method for an optical decorative film comprises:
applying a polymer on a first side of a support layer, and forming a plurality of micro-nano structures on the polymer;
forming a decorative layer on a second side of the support layer.

In one embodiment, the second side of the support layer is coated with a polymer, and a plurality of texture structures are formed on the polymer; or the second side of the support layer is coated with a polymer, and a plurality of grooves are formed on the polymer, and then filled with materials to form a graphic layer; or the second side of the support layer is coated with a polymer, and a plurality of grooves are formed on the polymer and then filled with materials to form a colorful layer.

In one embodiment, the first side of the support layer is implemented first; or the second side of the support layer is implemented first; or the first and second sides of the support layer are simultaneously implemented.

The present invention has the following advantageous effects: an optical layer and a decorative layer are respectively provided on a first side and a second side of a support layer, which produces a dual decorative effect and is highly distinctive, with only one support layer to realize a relatively small thickness.

### BRIEF DESCRIPTION OF THE DRAWINGS

FIG. 1 is a schematic view of a structure of the optical decorative film according to the present invention;

FIG. 2 is a schematic view of another structure of the optical decorative film according to the present invention;

FIG. 3 is a schematic view of another structure of the optical decorative film according to the present invention;

FIG. 4 is a schematic view of another structure of the optical decorative film according to the present invention;

FIG. 5 is a schematic view of another structure of the optical decorative film according to the present invention;

FIG. 6 is a schematic view of another structure of the optical decorative film according to the present invention;

FIG. 7 is a schematic view of another structure of the optical decorative film according to the present invention;

FIG. 8 is a schematic view of another structure of the optical decorative film according to the present invention;

FIG. 9 is a schematic view of another structure of the optical decorative film according to the present invention;

FIG. 10 is a schematic view of another structure of the optical decorative film according to the present invention;

FIG. 11 is a schematic view of another structure of the optical decorative film according to the present invention;

FIG. 12 is a schematic view of a structure of a cover plate for consumer electronics according to the present invention;

FIG. 13 is a flowchart of a manufacturing process for the optical decorative film according to the present invention.

### DETAILED DESCRIPTION OF THE INVENTION

For a better understanding of the present invention, more detailed description of the present invention will now be provided below with reference to the accompanying drawings. In the drawings, preferred embodiments of the invention are illustrated. However, the present invention can be implemented in many different forms and is not limited to the embodiments described below. On the contrary, these embodiments are given in order to provide a more thorough and complete understanding of the disclosure of the present invention.

Unless defined otherwise, all technical and scientific terms used herein have the same meaning as commonly understood by a person skilled in the art to which this invention belongs. The terms used herein in the description of the present invention are only for the purpose of describing specific embodiments, and are not intended to limit the present invention. The term “and/or” as used herein includes any and all combinations of one or more of relevant items listed.

The present invention discloses an optical decorative film which comprises a support layer, an optical layer, and a decorative layer. The support layer includes a first side and an opposite second side. The optical layer is formed on the first side, and includes a plurality of micro-nano structures in a convex and/or concave arrangement. The decorative layer is provided on the second side and is supported by the support layer. The first side and the second side of the support layer are respectively provided with an optical layer and a decorative layer, which produces a duel decorative effect and is highly distinctive, with only one support layer to realize a relatively small thickness.

The decorative layer is provided on the second side and is supported by a support layer. Both the optical layer and the decorative layer are supported by a support layer, and share the same support layer. The support layer has a certain thickness and hardness, and is for example PET, glass etc., to facilitate forming of the optical layer and the decorative layer, and to play a role of supporting. Structures are provided on both sides of the support layer to maximize the decorative effect and reduce the overall thickness of the optical decorative film.

Preferably, the decorative layer includes a reflective layer overlying the second side and a colored layer overlying the reflective layer. The optical layer is disposed on the first side of the support layer, and the reflective layer and the colored layer are disposed on the second side of the support layer. The process is simple and the decorative effect is excellent. As compared to the case they are separately formed on a support layer and then stacked, the thickness is reduced.

Preferably, the decorative optical film further includes a protective layer overlying the optical layer for protecting the micro-nano structures, and the difference in refractive index between the protective layer and the micro-nano structures is greater than or equal to 0.01, thereby ensuring the optical characteristics of the micro-nano structures.

Preferably, the support layer includes a glass layer, a PET layer, a PC layer, or a PMMA layer. That is, the support layer of the decorative optical film has a single-layer structure, and an optical layer and a decorative layer are respectively provided on both sides of the support layer, thereby enhancing the decorative effect and reducing the overall thickness of the decorative optical film.

Preferably, in order to ensure the visual effect, it is necessary to have a transmittance of the support layer and the optical layer of 10% or more, or a transmittance of the support layer and the decorative layer of 10% or more.

Preferably, the decorative layer includes one layer of a texture layer, a graphic layer, or a colorful layer, or superimposed layers of two or more thereof. Alternatively, the decorative layer includes a composite layer of a colorful texture layer or a colorful graphic layer. The texture layer includes a plurality of texture structures in a convex and/or concave arrangement. The superimposed layers are vertically stacked two or more layers, for example, a colorful layer and a texture layer provided on the colorful layer. A composite layer is that two layers shares a fused and overlapping part, e.g., the UV resin forming a texture layer is colored itself.

Preferably, the micro-nano structures are one or more of linear cylindrical lens, curved cylindrical lens, micro lens, Fresnel lens, CD patterns, short lines, moth-eye structures, brushed patterns, with or without spacing provided between the micro-nano structures. The texture structures are one or more of linear cylindrical lens, curved cylindrical lens, micro lens, Fresnel lens, CD patterns, short lines, moth-eye structures, brushed patterns, with or without spacing provided between the texture structures. The micro-nano structures and the texture structures are not associated with each other and do not interfere with each other, that is, they are independently provided.

Preferably, the micro-nano structures are in a gradient arrangement. For example, the micro-nano structures are cylindrical lens with their width gradually decreasing in one direction of arrangement.

Preferably, the texture structures are in a gradient arrangement. For example, the texture structures have a cross section in the form of grooves with their width increasing along one direction of arrangement.

Preferably, the graphic layer includes a UV resin with grooves and a filler filled inside the grooves, and the filler forms the graphic of the graphic layer. The graphic is not within the focal length of the micro-nano structures, that is, the graphics and the micro-nano structures do not adapt to form an image.

Preferably, the colorful layer has a gradient color. For example, the colorful layer includes a UV resin layer with gradient grooves and a colorful material filled inside the grooves. The colorful material per unit area is disposed in a gradient such that the colorful layer presents a gradient color.

Preferably, the support layer is a PET layer, and the thickness of the PET layer is greater than that of the decorative layer. Because the decorative layer is directly formed on the PET layer, or the decorative layer is first formed on another substrate and then bonded to the PET layer after the substrate is separated, the decorative layer may be regarded as free of substrate, which means the decorative layer has an overall thickness less than that of the PET layer. By forming a decorative layer on the other side of the PET layer according to the present invention, the decorative effect is further enhanced, while the thickness of the entire decorative optical film is still controlled and is greatly reduced as compared to that of simply stacked decorative PET films, which meets the requirements of the market development.

Preferably, the optical decorative film has a colored layer, a reflective layer, an optical layer, a support layer, and a decorative layer stacked in this order. In other embodiments, a colorful layer and/or a graphic layer may certainly be further included between the optical layer and the support layer.

Preferably, the decorative layer is stacked with a colorful layer and a texture layer in this order; or the decorative layer is stacked with a graphic layer and a texture layer in this order; or the decorative layer is stacked with a colorful layer and a graphic layer in this order; or the decorative layer comprises a colorful layer, a graphic layer, and a texture layer.

Preferably, the decorative layer further comprises a binding layer that binds the decorative layer to the second side of the support layer.

Preferably, the colorful layer is a gradient color layer. In a predetermined direction, the color gradually lightens or darkens. For example, the color gradually lightens from top to bottom; or the color gradually lightens from both sides inward.

Preferably, the texture structures of the texture layer are in a gradient arrangement. In a predetermined direction, the duty ratio per unit area is set in a gradient.

Preferably, the decorative layer may include at least two or more colorful layers.

Preferably, the decorative layer may include at least two or more graphic layers.

Preferably, the decorative layer may include at least two or more texture layers.

The invention also discloses a cover plate for consumer electronics that comprises the optical decorative film as described above, for example, a cover plate for cell phones. A cell-phone cover plate with the optical decorative film has a better decorative effect and is highly noticeable, and despite having both an optical layer and a decorative layer, it has only one support layer, which does not increase the thickness of the cell-phone cover plate and meets the trend of development in the market in terms of lightness and thinness.

The invention also discloses a manufacturing method for an optical decorative film, comprising the following steps:

Step 1, coating a first side of the support layer with a polymer, preferably a UV resin, and then forming a plurality of micro-nano structures on the UV resin;

Step 2, bonding the decorative layer to the second side of the support layer via a polymer layer of the decorative layer.

Step 1 may be performed first, and then step 2; alternatively, step 2 may be performed first, and then step 1; or both steps 1 and 2 may be performed simultaneously.

Step 1 may further include vapor depositing a reflective layer on the plurality of micro-nano structures, and applying a colored layer (preferably an ink priming layer) on the reflective layer.

An alternative manufacturing method for an optical decorative film according to the present invention includes the following steps:

Step 1, applying a polymer (preferably a UV resin) on the first side of the support layer, and forming a plurality of micro-nano structures on the polymer;

Step 2, forming a decorative layer on the second side of the support layer.

Step 1 may be performed first, and then step 2; alternatively, step 2 may be performed first, and then step 1; or both step 1 and step 2 may be performed simultaneously.

Step 1 may further include vapor depositing a reflective layer on the plurality of micro-nano structures, and applying a colored layer (preferably an ink priming layer) on the reflective layer.

In step 2, more specifically, the second side of the support layer is coated with a polymer (preferably a UV resin) and a plurality of texture structures are formed on the polymer. Alternatively, the second side of the support layer is coated with a polymer (preferably a UV resin), a plurality of grooves are formed on the polymer and the grooves are filled with materials to form a graphic layer. Alternatively, the second side of the support layer is coated with a polymer (preferably a UV resin), a plurality of grooves is formed on the polymer and the grooves are filled with materials (colorful materials) to form a colorful layer.

The embodiments of the present invention will be described hereinafter in more details with reference to the drawings.

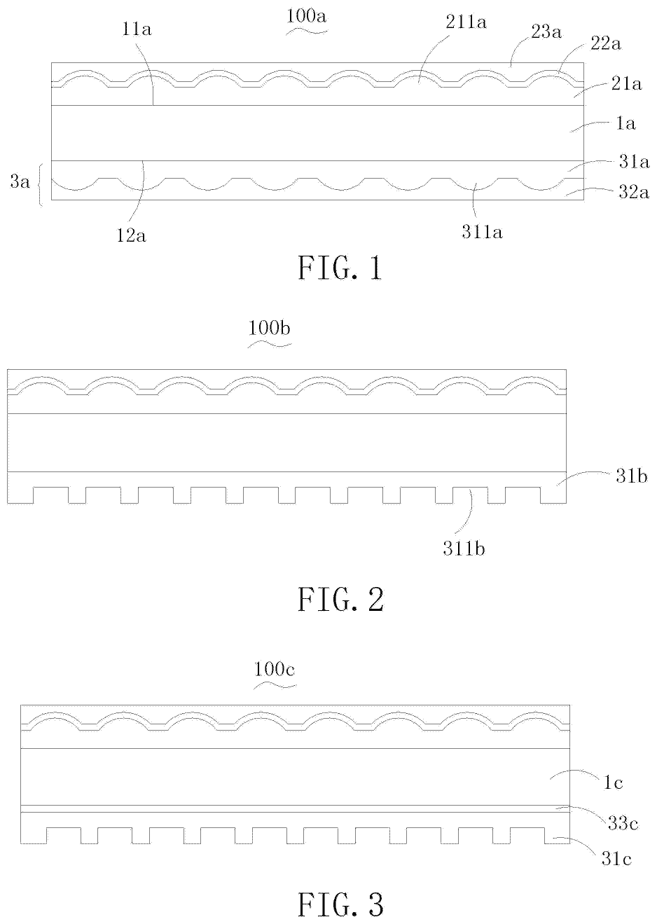

Referring to FIG. 1, an optical decorative film 100a includes a support layer 1a, an optical layer 21a, and a decorative layer 3a. The support layer 1a includes a first side 11a and an opposite second side 12a. The optical layer 21a is disposed on the first side 11a, and the optical layer 21a includes a plurality of micro-nano structures 211a in a convex arrangement. The decorative layer 3a is disposed on the second side 12a and is supported by the support layer 1a. Preferably, the micro-nano structures 211a are curved cylindrical lens. The optical decorative film 100a further includes a reflective layer 22a overlying the optical layer 21a and a colored layer 23a overlying the reflective layer 22a. The decorative layer 3a includes a texture layer 31a formed on the second side 12a and a protective layer 32a overlying the texture layer 31a. The texture layer 31a includes a plurality of texture structures 311a in a convex arrangement. The texture structures 311a are curved cylindrical lens. The micro-nano structures 211a are spaced from each other on the first side 11a, and the texture structures 311a are spaced from each other on the second side 12a. On a projection plane parallel to the first side 11a, the micro-nano structures 211a and the texture structures 311a are staggering with each other and do not completely overlap. The optical layer 21a may present bright light-and-shadow streaks, while the texture layer 31a may present another type of bright light-and-shadow streaks, and the two types of bright light-and-shadow streaks may be present independently and do not interfere with each other. The optical layer 21a and the decorative layer 3a are respectively disposed on the first side 11a and the second side 12a of the support layer 1a, which brings about a duel decoration effect and is highly distinctive, and the thickness of the optical decorative film is greatly reduced in comparison to the case where the optical layer and the decorative layer each requires a support layer.

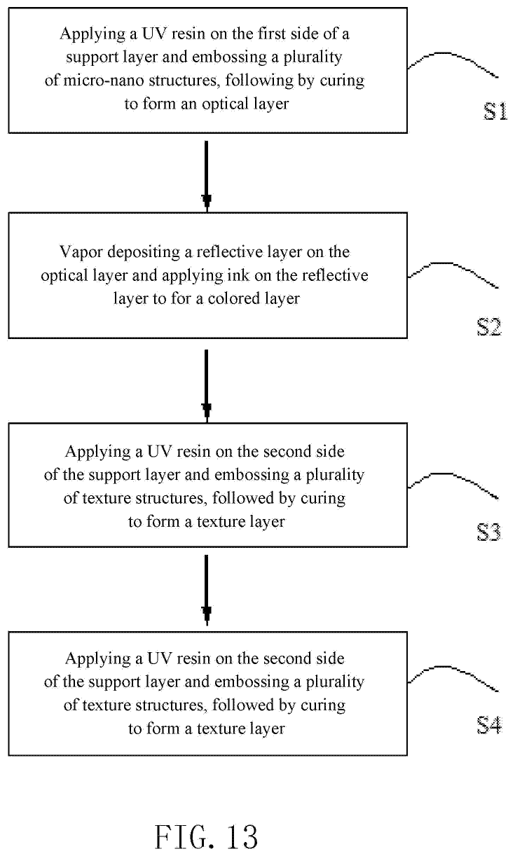

Now referring to FIG. 13, a manufacturing method for the optical decorative film 100a includes the following steps:

step S1, applying a UV resin on the first side 11a of a support layer 1a, and embossing a plurality of micro-nano structures 211a, followed by curing to form an optical layer 21a;

step S2, vapor depositing a reflective layer 22a on the optical layer 21a, and applying ink on the reflective layer 22a to form a colored layer 23a;

step S3, applying a UV resin on the second side 12a of the support layer 1a, and embossing a plurality of texture structures 311a, followed by curing to form a texture layer 31a;

step S4, applying a protective polymer on the texture layer 31a to form a protective layer 32a.

On the first side 11a and the second side 12a of a support layer 1a are provided with an optical layer 21a and a texture layer 31a, respectively, which brings about a duel decorative effect and a small overall thickness.

In other examples, steps S3 and S4 may be performed before steps S1 and S2.

In other examples, step S1 and step S3 are performed simultaneously.

The reflective layer 22a is made of a material having a reflective effect, such as metal or nonmetal, and the colored layer 23a is a priming ink layer. The transmittance of the support layer 1a and the decorative layer 3a is 10% or more, preferably 70% to 95%, which may ensure the visibility of the optical effect of the optical layer 21a.

The protective layer 32a is in contact with and protects the texture structures 311a. The difference in refractive index between the protective layer 32a and the texture structures 311a is greater than or equal to 0.1, preferably greater than or equal to 0.5, which may ensure the optical effect of the texture structures 311a.

Now referring to FIG. 2, an optical decorative film 100b differs from the optical decorative film 100a in that: the texture structures 311b of the texture layer 31b are grooves in a concave arrangement, and the grooves has a quadrangular cross section.

Referring to FIG. 3, as compared to the optical decorative film 100b, an optical decorative film 100c is provided with a colorful layer 33c between the support layer 1c and the texture layer 31c.

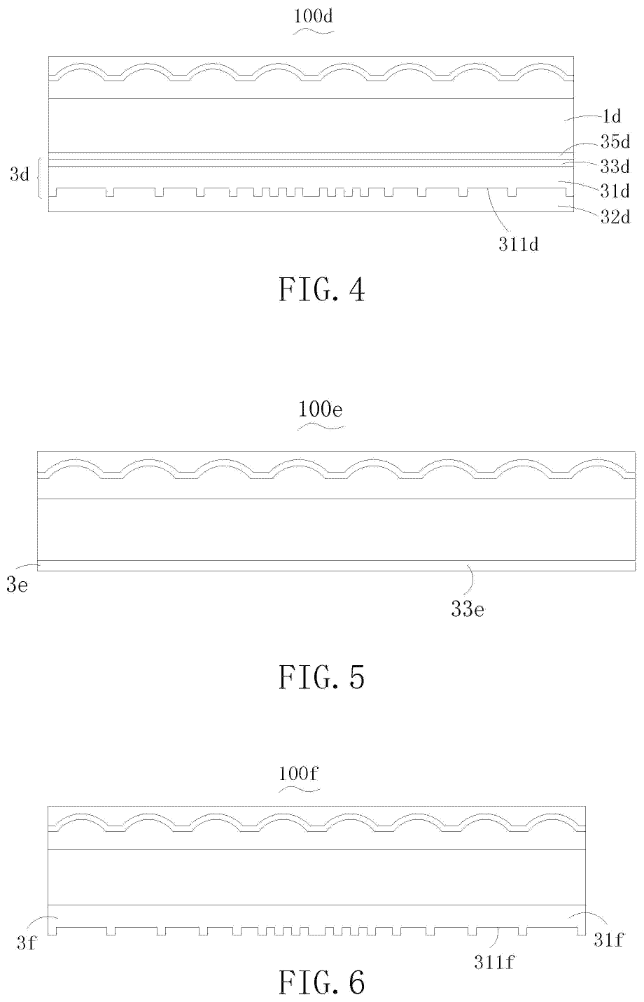

Referring to FIG. 4, an optical decorative film 100d has a decorative layer 3d including a binding layer 35d, a colorful layer 33d, a texture layer 31d, and a protective layer 32d. The binding layer 35d bonds the support layer 1d to the colorful layer 33d, the texture layer 31d is disposed on the colorful layer 33d, and the protective layer 32d is disposed on the texture layer 31d. The texture layer 31d includes a plurality of texture structures 311d set in a gradient arrangement, and the texture structures 311d are groove structures.

Referring to FIG. 5, an optical decorative film 100e has a decorative layer 3e including a colorful layer 33e.

Referring to FIG. 6, an optical decorative film 100f has a decorative layer 3f including a texture layer 31f, and the texture layer 31f has texture structures 311f in a gradient arrangement and is a colored composite layer.

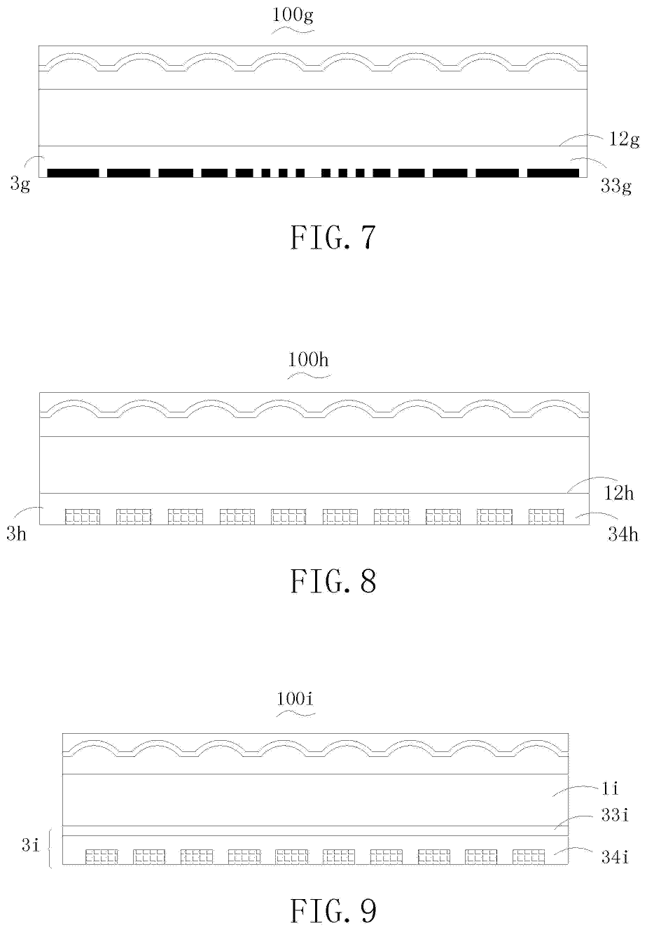

Referring to FIG. 7, an optical decorative film 100g has a decorative layer 3g including a gradient colorful layer 33g. A UV resin is applied on the second side 12g and grooves are embossed thereon before curing, and a colorful material is filled in the grooves. In a direction of arrangement, the width of the grooves gradually decreases from both sides inward. After the grooves are filled with the colorful material, the colorful layer 33g presents a gradient color.

Referring to FIG. 8, an optical decorative film 100h has a decorative layer 3h including a graphic layer 34h. A UV resin is applied on the second side 12h and grooves are embossed thereon before curing, and a material is filled in the grooves to form a graphic.

Referring to FIG. 9, an optical decorative film 100i has a decorative layer 3i including a colorful layer 33i and a graphic layer 34i. The colorful layer 33i is disposed between a support layer 1i and the graphic layer 34i.

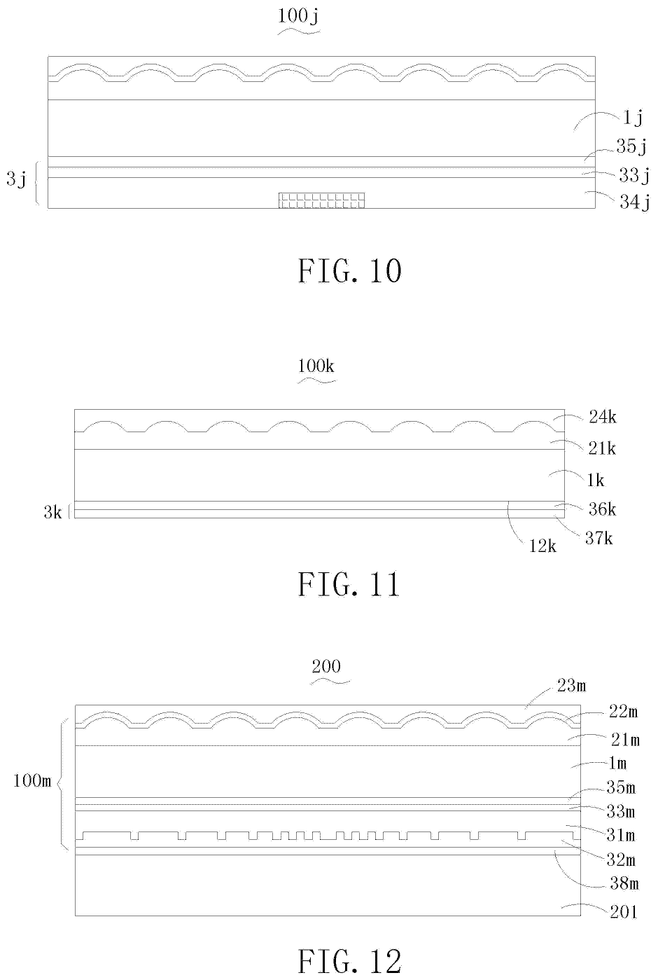

Referring to FIG. 10, an optical decorative film 100j has a decorative layer 3j including a binding layer 35j, a colorful layer 33j, and a graphic layer 34j. The graphic layer 34j is disposed on the colorful layer 33j, and the colorful layer 33j is bonded to a support layer 1j through the binding layer 35j. The graphic layer 34j shows a graphic “LOGO”.

Referring to FIG. 11, an optical decorative film 100k has an optical layer 21k on which a protective layer 24k is disposed, and a decorative layer 3k including a reflective layer 36k and a colored layer 37k. The reflective layer 36k is a film layer deposited on the second side 12k. The colored layer 37k is a priming ink layer.

Referring to FIG. 12, a cover plate for consumer electronics 200 includes a substrate layer 201 and an optical decorative film 100m bonded to the substrate layer 201. The optical decorative film 100m has a colored layer 23m, a reflective layer 22m, an optical layer 21m, a support layer 1m, a binding layer 35m, a colorful layer 33m, a texture layer 31m, a protective layer 32m, and a second binding layer 38m stacked in this order. The second binding layer 38m is bonded to the substrate layer 201. Preferably, the substrate layer 201 is glass. The consumer electronics include cell phones, tablet computers, laptops, cameras and the like.

In order to make the foregoing objects, features, and advantages of the present invention more understandable, description of the specific embodiments of the present invention is provided in details above with reference to the accompanying drawings. Many specific details are provided in the above description for the purpose of providing a thorough understanding of the present invention. However, the present invention can be implemented in many ways other than those described above and a person skilled in the art can make similar changes without departing from the spirit of the present invention, and therefore the present invention is not limited to the specific embodiments disclosed above. In addition, the technical features in the examples as described above can be arbitrarily combined. For the sake of conciseness, not all possible combinations of every technical features in the above examples are illustrated, but any combination of these technical features should be regarded as within the scope of the present disclosure as long as there is no contradiction in such a combination.

The above examples only demonstrate several embodiments of the present invention which, though described in abundant details, cannot be construed as limitation to the patentable scope of the present invention. It should be noted that, for those of ordinary skills in the art, various changes and modifications can be made without departing from the concept of the present invention and all fall within the protection scope of the present invention. As such, the protection scope of the present invention is defined by the claims appended.

What is claimed is:

1. An optical decorative film, characterized in comprising:
a support layer having a first side and an opposite second side;
an optical layer provided on the first side, and the optical layer has a plurality of micro-nano structures in a convex and/or concave arrangement; and
a decorative layer provided on the second side and supported by the support layer.

2. The optical decorative film according to claim 1, characterized in that the decorative layer includes a reflective layer overlying the second side and a colored layer overlying the reflective layer.

3. The optical decorative film according to claim 2, characterized in that further comprising a protective layer overlying the optical layer for protecting the micro-nano structures, wherein the difference in refractive index between the protective layer and the micro-nano structures is greater than or equal to 0.01.

4. The optical decorative film according to claim 1, characterized in that the decorative layer includes one layer of a texture layer, a graphic layer, or a colorful layer, or superimposed layers of two or more thereof, and wherein the texture layer comprises a plurality of texture structures in a convex and/or concave arrangement.

5. The optical decorative film according to claim 1, characterized in that the decorative layer includes a composite layer of colorful texture layers or colorful graphic layers, and wherein the texture layer comprises a plurality of texture structures in a convex and/or concave arrangement.

6. The optical decorative film according to claim 4, characterized in that the micro-nano structures are one or more of linear cylindrical lens, curved cylindrical lens, micro lens, Fresnel lens, CD patterns, short lines, moth-eye structures, brushed patterns, with or without spacing provided between the micro-nano structures; the texture structures are one or more of linear cylindrical lens, curved cylindrical lens, micro lens, Fresnel lens, CD patterns, short lines, moth-eye structures, brushed patterns, with or without spacing provided between the texture structures.

7. The optical decorative film according to claim 6, characterized in that the decorative layer includes a texture layer with no interference between the micro-nano structures and the texture structures.

8. The optical decorative film according to claim 6, characterized in that the micro-nano structures are in a gradient arrangement, and/or the texture structures are in a gradient arrangement.

9. The optical decorative film according to claim 4, characterized in that the graphic layer comprises a UV resin with grooves and a filler filled inside the grooves, and the filler forms the graphic of the graphic layer.

10. The optical decorative film according to claim 4, characterized in that the colorful layer comprises a UV resin layer with gradient grooves and a colorful material filled inside the grooves, and the colorful layer presents a gradient color.

11. The optical decorative film according to claim 1, characterized in that the support layer is a PET layer having a thickness larger than that of the decorative layer.

12. The optical decorative film according to claim 1, characterized in that a colorful layer and/or a graphic layer is further provided between the optical layer and the support layer.

13. The optical decorative film according to claim 1, characterized in that the decorative layer is stacked with a colorful layer and a texture layer in this order; or the decorative layer is stacked with a graphic layer and a texture layer in this order; or the decorative layer is stacked with a colorful layer and a graphic layer in this order; or the decorative layer comprises a colorful layer, a graphic layer, and a texture layer.

14. The optical decorative film according to claim 13, characterized in that the decorative layer further comprises a binding layer that binds the decorative layer to the second side of the support layer.

15. The optical decorative film according to claim 13, characterized in that the colorful layer is a gradient color layer, and/or the texture structures of the texture layer are in a gradient arrangement.

16. The optical decorative film according to claim 4, characterized in that the decorative layer at least includes two or more colorful layers, and/or the decorative layer at least includes two or more graphic layers, and/or the decorative layer at least includes two or more texture layers.

17. A cover plate for consumer electronics, characterized in comprising the optical decorative film according to claim 1.

18. A manufacturing method for an optical decorative film, characterized in comprising:
applying a polymer on a first side of a support layer, and forming a plurality of micro-nano structures on the polymer;
forming a decorative layer on a second side of the support layer; or binding a decorative layer through a binding layer thereof to a second side of the support layer.

19. The manufacturing method for an optical decorative film according to claim 18, characterized in that the second side of the support layer is coated with a polymer, and a plurality of texture structures are formed on the polymer; or
the second side of the support layer is coated with a polymer, a plurality of grooves is formed on the polymer, and then filled with materials to form a graphic layer; or
the second side of the support layer is coated with a polymer, a plurality of grooves is formed on the polymer, and then filled with materials to form a colorful layer.

20. The manufacturing method for an optical decorative film according to claim 18, characterized in that the first side of the support layer is implemented first; or the second side of the support layer is implemented first; or the first and second sides of the support layer are simultaneously implemented.
